(19) United States
(12) Patent Application Publication
(10) Pub. No.: US 2013/0043110 A1
(43) Pub. Date: Feb. 21, 2013

(54) SYSTEM FOR PROVIDING A BENDABLE ROLLING CONVEYOR GUIDE

(71) Applicants: William R. Mason, Kissimmee, FL (US); Russell W. Mason, Winchester, TN (US)

(72) Inventors: William R. Mason, Kissimmee, FL (US); Russell W. Mason, Winchester, TN (US)

(21) Appl. No.: 13/476,177

(22) Filed: May 21, 2012

Related U.S. Application Data
(60) Provisional application No. 61/524,965, filed on Aug. 18, 2011.

(51) Int. Cl. B65G 21/20

(52) U.S. Cl. 198/836.1

(57) ABSTRACT

A system for guiding an item moving along a conveyor, the system including a pair of spaced axle-positioning members having a plurality of releasable attachment receivers on a first edge and a plurality of curvature gaps on a second edge with a respective single curvature gap of the plurality of curvature gaps being positioned in relation with at least two releasable attachment receivers to effect a desired bend, a plurality of axles extending between the axle-positioning members with each axle being individually held in place by respective releasable attachment receivers, and one or more rotatable elements mounted on each individual axle, the rotatable elements covering a uniform location on each individual axle.

### CROSS-REFERENCE TO RELATED APPLICATIONS

This application claims the benefit of U.S. Provisional Application No. 61/524,965 filed Aug. 8, 2011, and incorporated herein by reference in its entirety.

### BACKGROUND OF THE INVENTION

Exemplary embodiments of the present invention relate generally to a guide used in a conveyer system and, more specifically, to a bendable guide for use along both curved and straight sections of the conveyer system with roller elements that extend completely vertically between a bottom and a top of the guide along respective axles.

Certain industries utilize conveyor systems which include guides mounted on opposite sides of a conveyor system for moving objects from one location to another, such as through a processing system. Such conveyor systems may also be used to arrange items into an orderly flow through a processing system. The guides for such conveyor systems may include either fixed or rolling elements to assist with the movement of objects through the conveyor system. Fixed roller elements provide a generally smooth surface for items to contact. Rolling elements provide rotatable elements mounted upon axles which make contact with the items being moved along the conveyer system. Whether the roller elements are fixed or rolling may be established based on the type of element that is being conveyed.

Both fixed and rolling elements provide a low friction guiding surface. Excess friction can cause line stoppage, package jamming, possible damage to conveyed items, product spillage, and/or skewed orientation. Rolling elements currently have a gap or opening near a top or bottom of the guide because axles extend vertically between a top and bottom of the guide, onto which the rolling elements are placed. To minimize the gap between rolling elements on adjacent axles, a spacer is located at an end of each axle. The positioning of the spacers is situated where a first axle may have the spacer proximate the bottom of the guide and an adjacent axle has the spacer proximate the top of the guide. This configuration results in open areas between the rolling elements being reduced. However, the spacer essentially creates an opening since the item passing along the conveyor does not make contact with the spacer. Further, if the spacer was of a wide enough diameter to contact the item passing along the conveyor, the change in friction between the roller elements and enlarged spacer may damage the items being moved, cause product spillage, and/or skew orientation.

The spacer is usually of a smaller diameter than the other rollers and does not roll. Thus, the spacer does not make contact with an item passing through the conveyor system.

### BRIEF DESCRIPTION OF THE INVENTION

Exemplary embodiments of a system for guiding an item moving along a conveyor are disclosed herein. The system comprises a pair of spaced axle-positioning members having a plurality of releasable attachment receivers on a first edge and a plurality of curvature gaps on a second edge with a respective single curvature gap of the plurality of curvature gaps being positioned in relation with at least two releasable attachment receivers to affect a desired bend. The system also comprises a plurality of axles extending between the axle-positioning members with each axle being individually held in place by respective releasable attachment receivers, and one or more rotatable elements mounted on each individual axle, the rotatable elements covering a uniform location on each individual axle.

Another exemplary embodiment of the system comprises an axle positioning member having an elongated shape with a plurality of releasable attachment receivers on a first edge and a plurality of curvature gaps on a second edge with a respective single curvature gap of the plurality of curvature gaps being positioned in relation with at least two releasable attachment receivers to effect a desired bend, and a channel into which the axle positioning member is inserted. The system further comprises at least a first axle and a second axle, each axle having a uniform length and symmetric configuration, with each axle being removeably attached to the axle positioning member at a respective adjacent releasable attachment receivers and each axle having a first end and a second end, and a plurality of first sized rotatable elements that fit on each axle. The system also comprises a plurality of second sized rotatable elements comprising a similar diameter as the first sized rotatable elements and a smaller height than the first sized rotatable elements wherein at least one of the second sized rotatable elements fit upon each axle. At least one second sized rotatable element is the last rotatable element on the first end of the first axle and at least one second sized rotatable element is the last rotatable element on the second end of the second axle to create an interlocked configuration between rotatable elements on adjacent axles with the rotatable elements covering a uniform distance on each axle.

Another exemplary embodiment of the system comprises a first axle positioning member and a second axle positioning member each being elongated in shape and each having a plurality of releasable attachment receivers on a first edge and a plurality of curvature gaps on a second edge having a single curvature gap of the plurality of curvature gaps positioned between at least two adjacent releasable attachment receivers. The system also comprises a support structure with a top channel into which the first axle positioning member is placed and a bottom channel into which the second axle positioning member is placed. The system further comprises at least a first axle and a second axle, each axle having a symmetric and equivalent appearance with a first end and a second end, with each axle being removeably attached to the axle positioning member at respective adjacent releasable attachment receivers between the first axle positioning member and the second axle positioning member. The system also comprises a plurality of first sized rotatable elements that fit around each axle, and a plurality of second sized rotatable elements comprising a similar diameter as the first sized rotatable elements and a smaller height than the first sized rotatable elements wherein at least one of the second sized rotatable elements fit around each axle. At least one of the second sized rotatable elements is the last rotatable element on the first end of the first axle and at least one of the second sized rotatable elements is the last rotatable element on the second end of the second axle to create an interlocked configuration between rotatable elements on adjacent axles with the rotatable elements covering a uniform distance on each axle.

### BRIEF DESCRIPTION OF THE DRAWINGS

A more particular description of the invention briefly described above will be rendered by reference to specific embodiments thereof that are illustrated in the appended drawings. Understanding that these drawings depict only typical embodiments of the invention and are not therefore to be considered to be limiting of its scope, the embodiments of the invention will be described and explained with additional specificity and detail through the use of the accompanying drawings in which:

FIG. 1 depicts an exemplary embodiment of a frontal view of a conveyor guide with rollers disclosed;

FIG. 2 depicts an exemplary embodiment of a frontal view of the support structure;

FIG. 3 depicts an exemplary embodiment of a bendable axle positioning member;

FIG. 4 depicts an exemplary embodiment of the bendable axle positioning member in a bent configuration;

FIG. 5 depicts another exemplary embodiment of a bendable axle positioning member;

FIG. 6 depicts another exemplary embodiment of a bendable axle positioning member;

FIG. 7 depicts an exemplary embodiment of a side view of a plurality of axles to be placed within an axle positioning member; and

FIG. 8 depicts an exemplary embodiment of a front view of the bendable guide.

### DETAILED DESCRIPTION OF THE INVENTION

Reference will be made below in detail to exemplary embodiments of the invention, examples of which are illustrated in the accompanying drawings. Wherever possible, the same reference numerals used throughout the drawings refer to the same or like parts. As disclosed below, multiple versions of a same element may be disclosed. Likewise, with respect to other elements, a singular version is disclosed. Neither multiple versions disclosed nor a singular version disclosed shall be considered limiting. Specifically, although multiple versions are disclosed, a singular version may be utilized. Likewise, where a singular version is disclosed, multiple versions may be utilized.

Though exemplary embodiments of the present invention are described with respect to conveyor systems, exemplary embodiments of the invention are also applicable for use with systems used to guide or direct movement and/or positing of objects.

Exemplary embodiments of the invention solve problems in the art by providing a system for guiding an item moving along a system or process, such as a conveyor system where a path the item takes is not a direct path, but may comprise curves and or bends in the path. Thus, broadly speaking, a technical effect is to guide an item moving along a path where that path may not be a straight path. To facilitate an understanding of the exemplary embodiments of the invention, it is described hereinafter with reference to specific implementations thereof.

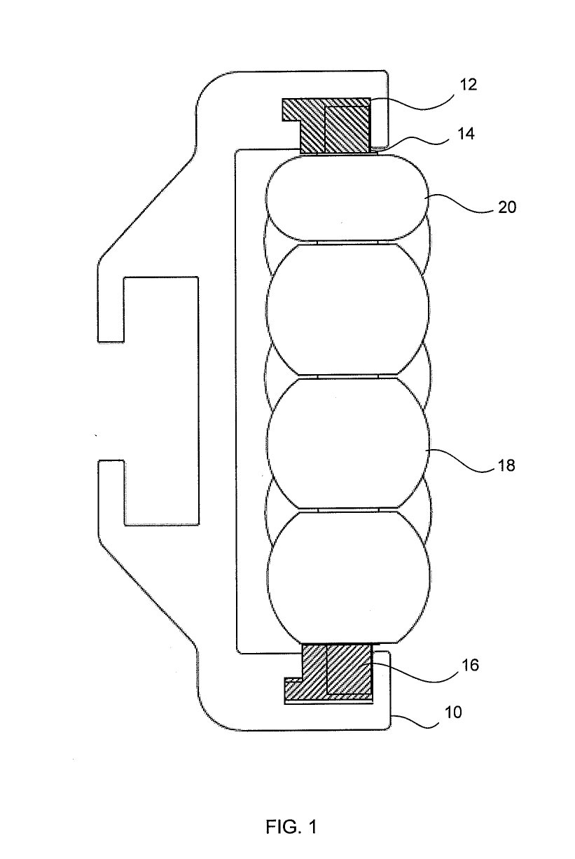

Referring now to the drawings, embodiments of the present invention will be described. FIG. 1 depicts an exemplary embodiment of a frontal view of a bendable rail. A support structure 10 is provided. Within the support structure are two channels 12, more specifically a top channel and a bottom channel. Respective axle positioning members 14 are located within each channel 12. The axle positioning members 14 may be slid through the respective channel 12, or in another exemplary embodiment inserted (or snapped) into the channel 12 where enough space may or may not be provided to allow the axle positioning member 14 to slide within the channel 12. Axles 16 extend between the two axle positioning members 14. Located around or on each axle is a plurality of rotatable elements 18, 20. As further disclosed, two different sized rotatable elements 18, 20 are located on the axle 16.

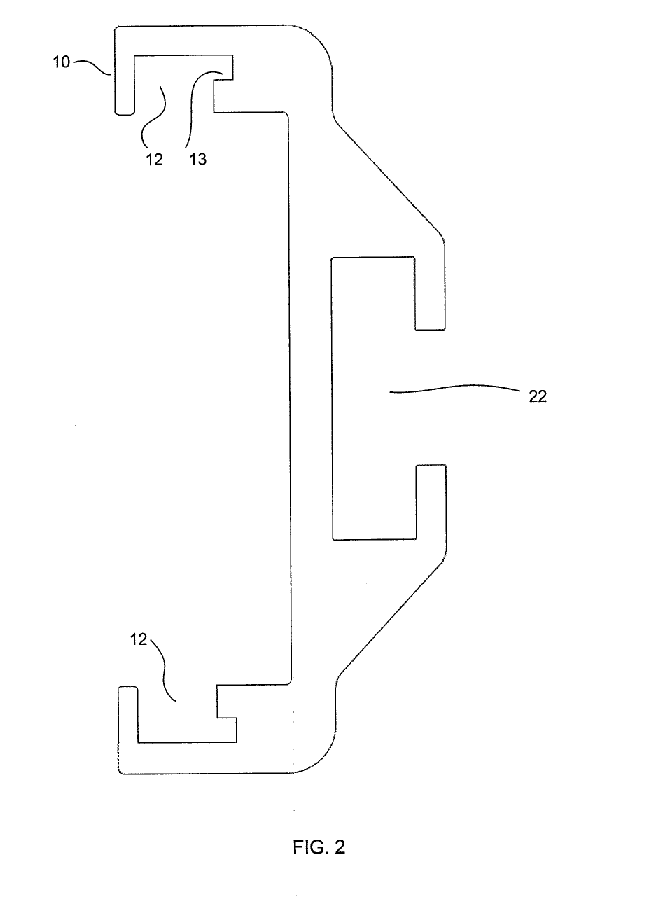

FIG. 2 depicts an exemplary embodiment of a frontal view of the support structure. In addition to the channels 12 into which the axle positioning members 14 are located, a securing element 22 is provided to secure the support structure 10 to, or next to, a conveyor (not illustrated). The channels 12 are configured with a location 13 to further secure the axle positioning member 14 within the channel 12. The support structure 10 is elongated where it may maintain a straight shape along its elongated length or may be bent or curved.

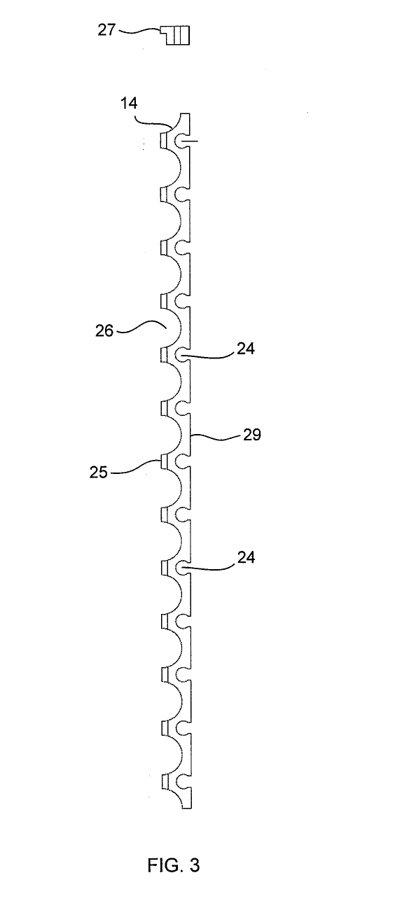

FIG. 3 depicts an exemplary embodiment of a bendable axle positioning member. The axle positioning member 14 is elongated in shape. Located on a first edge 29 of the axle positioning member 14 is a plurality of releasable attachment receivers 24 where a respective axle 16 may be located with a respective releasable attachment receiver 24. The releasable attachment receivers 24 are used to place fit, or snap fit, a respective axle into place. Spacing 29 is provided on the axle positioning member 14 between adjacent attachment receivers 24 to allow for the axle positioning member 14 to be bent where the bent configuration does not interfere with the function of combined axles and roller elements. On a second edge 25 (opposite of the first edge) of the axle positioning member 14 is a plurality of curvature gaps 26. A locking element 27 to hold the axle positioning member 14 within the channel 12 is also disclosed. The plurality of releasable attachment receivers and the plurality of curvature gaps assist to facilitate curvature, or bending, of the axle positioning member.

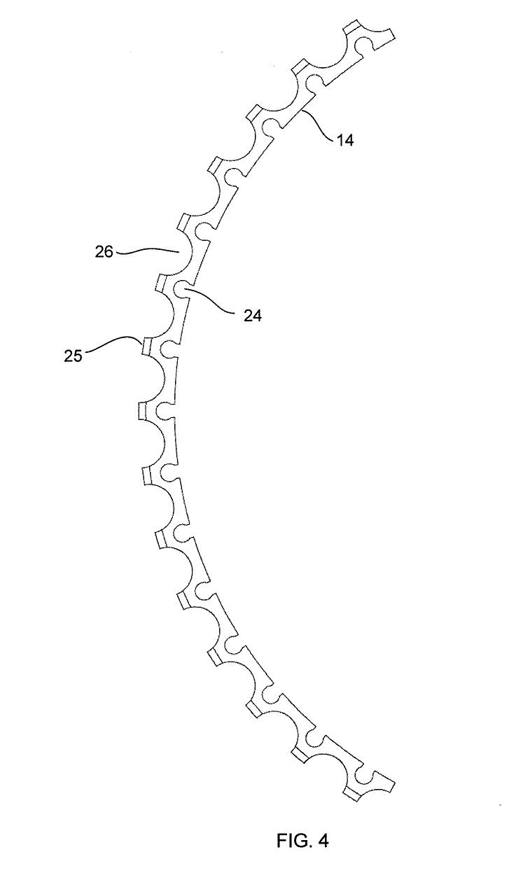

Looking from the top, when a single curvature gap is provided, it extends through an edge of a first adjacent releasable attachment receiver 24 at a first end and through an edge of a second adjacent attachment receiver 24 at a second end. This configuration provides for the axle positioning member 14 to have a leaf spring configuration, or parabolic-like curve (“parabolic curve”) when bent at a specific location where the specific location may be considered the vertex, as illustrated in FIG. 4. When the axle positioning member is bent, because of the curvature characteristics, no interference between the axle positioning member 14 or channel 12 is realized.

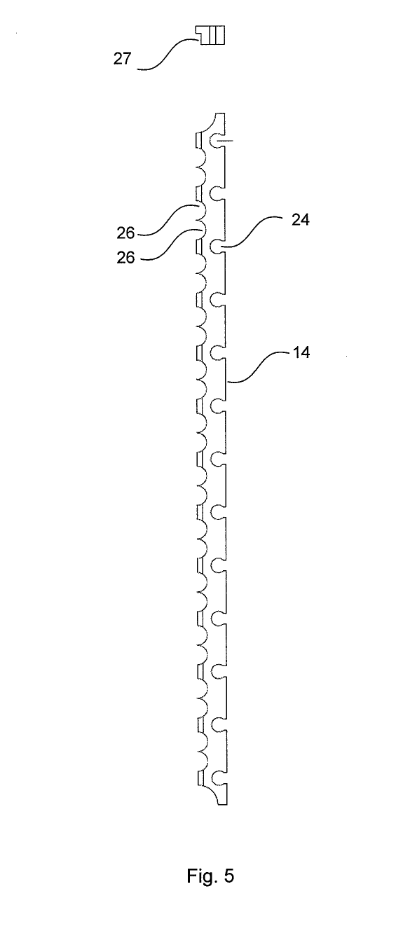

FIG. 5 depicts another exemplary embodiment of a bendable axle positioning member. As previously illustrated with respect to FIGS. 3 and 4, a single curvature gap 26 is positioned between at least two adjacent releasable attachment receivers 24. As illustrated in FIG. 5, more than one curvature gap 26 may be provided between two adjacent releasable attachment receivers 24.

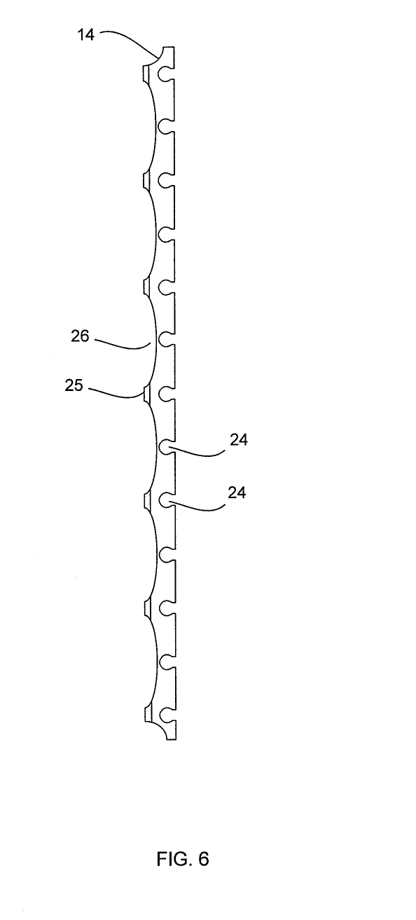

FIG. 6 depicts another exemplary embodiment of a bendable axle positioning member. In this exemplary embodiment, a single curvature gap 26 may extend to be positioned in bendable communication with more than two adjacent releasable attachment receivers. For example, the single curvature gap 26 may start with a first end at an edge of a first releasable attachment receiver 24 whether the deepest part of the gap is closest to the next adjacent releasable attachment receiver 24, and then the second end of the curvature gap 26 is at an edge of a third releasable attachment receiver 24 which is adjacent to the second releasable attachment receiver 24. Thus, in view of the bended shapes disclosed above, a respective single curvature gap 26 of the plurality of curvature gaps 26 may be positioned in a specific relation with at least two releasable attachment receivers 24 to effect, determine, and/or select a desired bend of the axle positioning member 14.

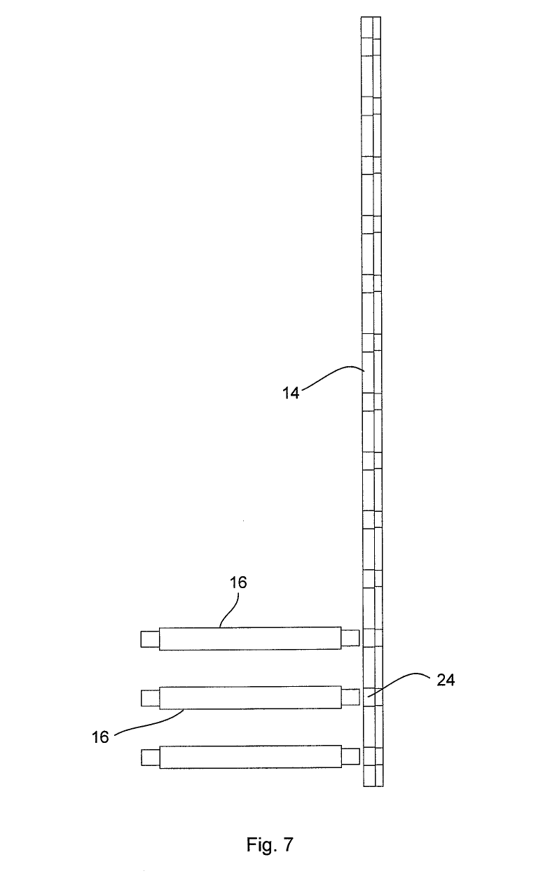

FIG. 7 depicts an exemplary embodiment of a side view of a plurality of axles to be placed within an axle positioning member. Unlike prior art axles which included a spacer to provide for interlocking operability between rolling elements on adjacent axles, each axle has a uniform configuration. Thus, a single axle configuration may be used to replace a damaged axle. Each single axle 16 has a first end and a second end where a respective end is positioned within a respective releasable attachment receiver 24 on the axle positioning member 14. Though other configurations are possible, as illustrated, the axles extend vertically from the first end to the second end.

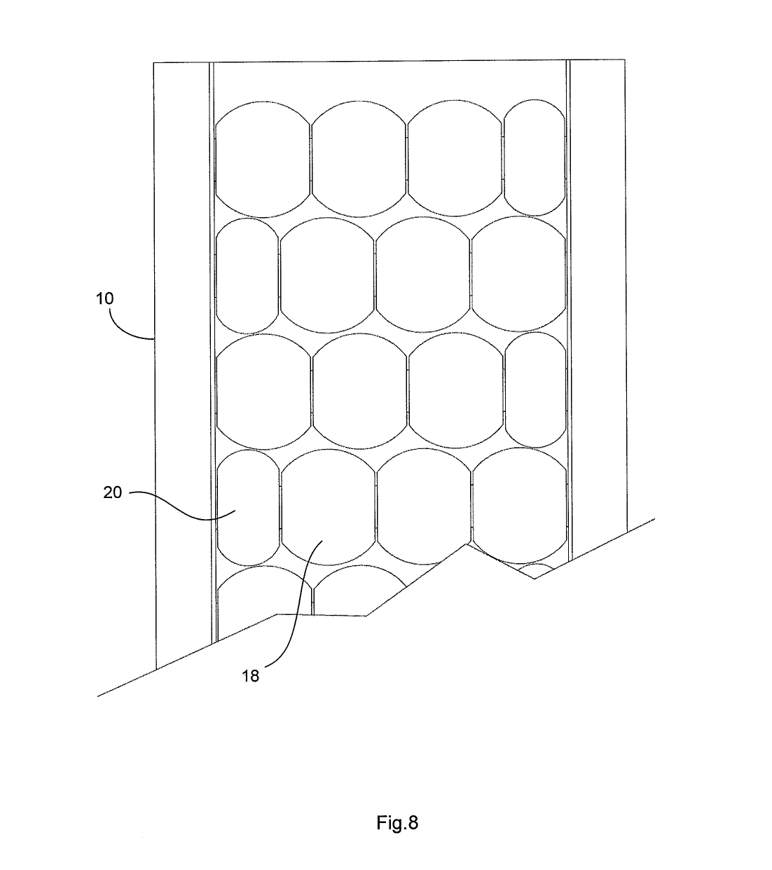

FIG. 8 depicts an exemplary embodiment of a front view of the bendable guide. As illustrated, one or more rotatable elements 18, 20 is provided on each axle 16. The rotatable elements have the same or similar diameter, but may have different heights. As illustrated, a first rotatable element 18 has a taller height than a second rotatable element 20. To provide for interlockability between rotatable elements on adjacent axles 16, at least one of the second sized rotatable elements 20 is the last rotatable element on the first end of a first adjacent axle 16 and at least one of the second sized rotatable elements 20 is the last rotatable element on the second end of a second adjacent axle 16 to create an interlocked configuration between rotatable elements on the adjacent axles 16 with the rotatable elements covering a uniform distance on each axle. In another exemplary embodiment, the rotatable elements at a particular end of each axle (as explained above) could be the first rotatable element 18 where the other plurality of rotatable elements 20 is the second rotatable elements 20. At uniform distance covered by, or extending from, the first sized rotatable elements and, or to, the at least one second sized rotatable element on a respective axle does not result in an open area remaining at either the first end or the second end of the axle. If left there, such an open area could cause damage to an object being moved along the conveyor.

As configured, should a roller or axle fail, instead of having to replace the complete guide, axle, rollers and/or a combination of any of these elements, a user has only to remove the guide, and remove an individual axle (which may be the part that failed) and/or the specific roller (which may be the part that failed). Thus, exemplary embodiments disclosed herein result in axles that are not molded integrally as one piece with the positioning member. Further, instead of having to replace all of the elements when a failure occurs, only the specific element, or sub-element (when considering the elements disclosed above as a whole), would have to be replaced.

While the invention has been described with reference to various exemplary embodiments, it will be understood by those skilled in the art that various changes, omissions and/or additions may be made and equivalents may be substituted for elements thereof without departing from the spirit and scope of the invention. In addition, many modifications may be made to adapt a particular situation or material to the teachings of the invention without departing from the scope thereof. Therefore, it is intended that the invention not be limited to the particular embodiment disclosed as the best mode contemplated for carrying out this invention, but that the invention will include all embodiments falling within the scope of the appended claims. Moreover, unless specifically stated any use of the terms first, second, etc., does not denote any order or importance, but rather the terms first, second, etc., are used to distinguish one element from another.

What is claimed is:

1. A system for guiding an item moving along a conveyor, the system comprising:
an axle positioning member having an elongated shape with a plurality of releasable attachment receivers on a first elongated edge and a plurality of curvature gaps on a second elongated edge with a respective single curvature gap of the plurality of curvature gaps being positioned in relation with at least two releasable attachment receivers to effect a desired bend;
a channel into which the axle positioning member is inserted;
at least a first axle and a second axle, each axle having a uniform length and symmetric configuration, with each axle being removeably attached to the axle positioning member at a respective adjacent releasable attachment receiver and each axle having a first end and a second end;
a plurality of first sized rotatable elements that fit on each axle;
a plurality of second sized rotatable elements comprising a similar diameter as the first sized rotatable elements and a smaller height than the first sized rotatable elements wherein at least one of the second sized rotatable elements fit upon each axle;
wherein at least one second sized rotatable element is the last rotatable element on the first end of the first axle and at least one second sized rotatable element is the last rotatable element on the second end of the second axle to create an interlocked configuration between rotatable elements on adjacent axles with the rotatable elements covering a uniform distance on each axle.

2. The system according to claim 1, wherein the single curvature gap is located between adjacent releasable attachment receivers and extends through an edge of a first adjacent releasable attachment receiver at a first end and through an edge of a second adjacent releasable attachment receiver at a second end.

3. The system according to claim 1, wherein the plurality releasable attachment receivers and the plurality of curvature gaps assist to facilitate curvature of the axle positioning member.

4. The system according to claim 3, wherein when bent at a specific location, the axle positioning member provides for a parabolic curve extending from the specific location.

5. The system according to claim 1, wherein when the axle positioning member is bent no interference between adjacent rolling elements is realized.

6. A system for guiding an item moving along a conveyor, the system comprising:
a first axle positioning member and a second axle positioning member each being elongated in shape and each having a plurality of releasable attachment receivers on a first edge and a plurality of curvature gaps on a second edge having a single curvature gap of the plurality of curvature gaps positioned between at least two adjacent releasable attachment receivers;
a support structure with a top channel into which the first axle positioning member is placed and a bottom channel into which the second axle positioning member is placed;
at least a first axle and a second axle, each axle having a symmetric and equivalent appearance with a first end and a second end, with each axle being removeably attached to the axle positioning member at respective adjacent releasable attachment receivers between the first axle positing member and the second axle positioning member;
a plurality of first sized rotatable elements that fit around each axle;
a plurality of second sized rotatable elements comprising a similar diameter as the first sized rotatable elements and a smaller height than the first sized rotatable elements wherein at least one of the second sized rotatable elements fit around each axle;
wherein at least one of the second sized rotatable elements is the last rotatable element on the first end of the first axle and at least one of the second sized rotatable elements is the last rotatable element on the second end of the second axle to create an interlocked configuration between rotatable elements on adjacent axles with the rotatable elements covering a uniform distance on each axle.

7. The system according to claim 6, wherein the single curvature gap located between adjacent releasable attachment receivers extends through an edge of a first adjacent releasable attachment receiver at a first end and through an edge of a second adjacent releasable attachment receiver at a second end.

8. The system according to claim 6, wherein the plurality releasable attachment receivers and the plurality of curvature gaps assist to facilitate curvature of the axle positioning member.

9. The system according to claim 8, wherein when bent at a specific location, the axle positioning member produces a parabolic curve extending from the specific location.

10. The system according to claim 6, wherein when the axle positioning member is bent no interference between adjacent rolling element is realized.

11. The system according to claim 6, wherein the uniform distance covered by the first sized rotatable elements and the at least one second sized rotatable element on a respective axle does not result in an open area remaining at either the first end or the second end of the axle where the open area could cause damage to an object being moved along the conveyor.

12. A system for guiding an item moving along a conveyor, the system comprising:
a pair of spaced axle-positioning members having a plurality of releasable attachment receivers on a first edge and a plurality of curvature gaps on a second edge with a respective single curvature gap of the plurality of curvature gaps being positioned in relation with at least two releasable attachment receivers to effect a desired bend;
a plurality of axles extending between the axle-positioning members with each axle being individually held in place by a respective releasable attachment receiver; and
one or more rotatable elements mounted on each individual axle, the rotatable elements covering a uniform location on each individual axle.

13. The system according to claim 12, wherein the one or more rotatable elements comprise:
at least one first sized rotatable elements that fits around each axle;
at least one second sized rotatable element comprising a similar diameter as the first sized rotatable elements and a smaller height than the first sized rotatable elements wherein the least one of the second sized rotatable element fits around each axle.

14. The system according to claim 13, wherein at least one of the second sized rotatable elements is the last rotatable element on the first end of a first adjacent axle and at least one of the second sized rotatable elements is the last rotatable element on the second end of a second adjacent axle to create an interlocked configuration between rotatable elements on the adjacent axles with the rotatable elements covering a uniform distance on each axle.

15. The system according to claim 13, wherein a plurality of first sized rotatable elements is mounted on each axle with at least one of the second sized rotatable elements.

16. The system according to claim 13, wherein a plurality of second sized rotatable elements is mounted on each axle with at least one of the second sized rotatable elements.

17. The system according to claim 13, wherein the at least one first sized rotatable element and the at least one second sized rotatable element create an interlocked configuration between rotatable elements on adjacent axles.

18. The system according to claim 12, wherein the single curvature gap extends through an edge of a first adjacent releasable attachment receiver at a first end and terminates through an edge of a second adjacent releasable attachment receiver at a second end.

19. The system according to claim 12, wherein the plurality of releasable attachment receivers and the plurality of curvature gaps assist to facilitate curvature of the axle positioning member.

20. The system according to claim 19, wherein when bent at a specific location, the axle positioning member produces a parabolic curve extending from the specific location.
